(19) United States
(12) Patent Application Publication
(10) Pub. No.: US 2009/0065225 A1
(43) Pub. Date: Mar. 12, 2009

(54) SWITCHABLE ANTI-LOCK CONTROL

(75) Inventors: Michael K. Forster, White Hall, MD (US); Kyle J. Wheaton, Edina, MN (US)

Correspondence Address: Harness Dickey & Pierce, P.L.C., P.O. Box 828, Bloomfield Hills, MI, 48303, US

(73) Assignee: Black & Decker Inc., Newark, DE (US)

(21) Appl. No.: 12/204,229

(22) Filed: Sep. 4, 2008

Related U.S. Application Data
(60) Provisional application No. 60/970,612, filed on Sep. 7, 2007.

(51) Int. Cl. B25F 5/00; H02H 7/08

(52) U.S. Cl. 173/2; 318/432; 173/1; 173/20

(57) ABSTRACT

A power tool can include a housing and a motor assembly in the housing. The motor assembly can include an output member and a motor for translating the output member. A kickback sensor can sample successive periods of current through the motor and produce an output in response thereto. An anti-kickback control device can remove energy from the output member in response to the output of the kickback sensor. A switch can have a first setting and a second setting. The first setting can correspond to a first operating condition of the anti-kickback control device. The second setting can correspond to a second operating condition of the anti-kickback control device.

### FIELD

The present disclosure relates to power tools, and more particularly to a switch for controlling the activation of an anti-lock or anti-kickback device configured on a power tool.

### BACKGROUND

Kickback is defined as that condition when the power driven tool or other implement abnormally and rapidly engages the workpiece in such a manner as to transfer at a high rate the power of the motive power source and/or the inertial energy of the power tool to the power tool or the workpiece or both resulting in an undesired and generally uncontrolled motion of the power tool or the workpiece or both. Kickback can be caused by a variety of factors including but not limited to sudden or excess force by the operator, non-uniform hardness or a defect in the workpiece, and where the workpiece is wood or other cellular material, the accumulation of moisture. In the case of a saw, the kerf may close and pinch the blade to cause a kickback, and in the case of a drill, kickback may occur when the bit breaks through the workpiece. Consider, for example, a portable circular saw of the type used on construction sites. Typically, plywood sheathing is first nailed to a framing structure, such as roofing trusses, and then the projecting ends of the plywood are sawed off evenly. If in this process a kickback were to occur due to the kerf closing as the ends of the wood sag under their own weight, the portable circular saw could kick out of the workpiece and fly back toward the operator, possibly resulting in serious bodily injury. On the other hand, in the case of a bench saw or a radial arm saw where the workpiece is fed into the saw blade, a kickback would result in the workpiece being driven back toward the operator at a high rate of speed, again with the possibility of serious bodily injury.

It will be understood by those familiar with the art that kickback is not a condition which is limited to circular saws but may be experienced with any power driven tool or machine tool system. For example, kickback may occur with portable, bench or stationary power drills, routers and shapers, portable and bench planers, abrasive wheel grinders, milling machines, reciprocating saws and the like. All of these tools are typically driven with electric motors, including universal, D.C., single phase or polyphase motors, but kickback is not a condition dependent on the motive power source but rather on the sudden abnormal engagement of the implement with the workpiece.

### SUMMARY

A power tool can include a housing and a motor assembly in the housing. The motor assembly can include an output member and a motor for translating the output member. A kickback sensor can sample successive periods of current through the motor and produce an output in response thereto. An anti-kickback control device can remove energy from the output member in response to the output of the kickback sensor. A switch can have a first setting and a second setting. The first setting can correspond to a first operating condition of the anti-kickback control device. The second setting can correspond to a second operating condition of the anti-kickback control device.

According to additional features, the first operating condition of the anti-kickback control device can include an “OFF” setting wherein the anti-kickback control device is turned off. The first operating condition can include a first threshold corresponding to a first rate of current change. The second operating condition can include a second threshold corresponding to a second rate of current change.

The power tool can further include a visual indicator. The anti-kickback control device can communicate a signal to the visual indicator based on the output of the kickback sensor. The switch can comprise a slidable switch configured on an upper portion of the housing. A reset switch can be in electrical communication with the anti-kickback control device. The reset switch can be operable to restart the power tool subsequent to a kickback condition being cleared.

The present teachings further provide a method of eliminating kickback in a power tool. The power tool can be of the type having an output spindle driven by an electric motor, the electric motor being supplied with current from an AC source. Successive periods of current can be sampled through the motor. A rate of change of the current can be determined in response to the sampling. The rate of change can be compared to a threshold. A selected position of a user actuated control switch having at least a first position and a second position can be determined. Energy is removed from the output spindle in response to the comparison and the position of the user actuated control switch.

According to one example, removing the energy can include inhibiting the supply of current to the motor if the rate of change exceeds a threshold. The method can further illuminate a light source based on the rate of change comparison.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is side view of an exemplary power tool constructed in accordance with the teachings of the present disclosure and shown with a portion of the housing removed;

FIG. 2 is a system block diagram illustrating various components of the power tool of FIG. 1;

FIG. 3 is a detail view of a kickback control switch and visual indicator according to one example of the present disclosure; and

FIG. 4 is a flow diagram illustrating general operation of the power tool according to the present teachings.

### DETAILED DESCRIPTION

With reference to FIGS. I and 2 of the drawings, a power tool constructed in accordance with the present teachings is generally indicated by reference numeral 10. As those skilled in the art will appreciate, the preferred embodiment of the present disclosure may be either a corded or cordless (battery operated) device, such as a portable screwdriver or drill. In the particular embodiment illustrated, the power tool 10 is a corded drill having a housing 12, a motor assembly 14, a transmission assembly 16, an output spindle 20, a chuck 22, a trigger assembly 24, and a power cord 28. The power tool 10 according to the present teachings can also include a kickback sensor 30 (FIG. 2), an anti-lock or anti-kickback control device 32 (FIG. 2), and a kickback control switch 34. Those skilled in the art will understand that several of the components of power tool 10, such as the motor assembly 14, transmission 16, chuck 22, and trigger assembly 24, may be conventional in nature and need not be described in significant detail in this application. Reference may be made to a variety of publications for a more complete understanding of the operation of the conventional features of power tool 10. One example of such publications is commonly assigned U.S. Pat. No. 5,897,454 issued Apr. 27, 1999, the disclosure of which is hereby incorporated by reference as if fully set forth herein.

In one example, the motor assembly 14 can include a motor 38 that is coupled to the output spindle 20 by way of the transmission 16. The transmission 16 may be simply a shaft providing direct drive from the motor 38 to the output spindle 20, a gear train providing speed increase or decrease, or any other coupling device. A brake 40 may be coupled to the motor 38 for decreasing rotational speed thereof. The power cord 28 can supply current from an AC source to the motor 38. For example, the brake 40 can me incorporated into the transmission 16. The kickback sensor 30 can derive motor current information from the motor 38. It is appreciated that shaft torque of the output spindle 20 can be measured indirectly by measuring the motor current. The rate of change of the motor current (dl/dt) can be computed and compared with a threshold value to detect an impending kickback condition. In one example, the anti-kickback control device 32 can differentiate the motor current with respect to time to obtain a measure of the increase or decrease in motor current. Digitally, the time rate of change can be approximated by periodically sampling the motor current and then making a computation among the different current readings. In other examples, the absolute current level can be measured and compared with a threshold value to detect an impending kickback condition.

It is appreciated that the anti-kickback control device 32 can determine whether a kickback condition exists by other methods. According to another example, the rate of change of motor speed (ds/dt) can be calculated and compared to a threshold. In another example, a percentage change in motor speed can be calculated and compared to a threshold. In another example, torque may be determined such as by a torque sensor (not shown) and compared to a threshold.

When an impending kickback condition is detected, the kickback sensor 30 can provide an output to the anti-kickback control device 32. The anti-kickback control device 32 can be responsive to the output of the kickback sensor 30 to remove energy from the output spindle 20. In one example, the motor 38 can be turned off. In another example, a clutch in the transmission 16 can be disengaged. In other examples, it may be necessary to additionally or alternatively apply the brake 40 to the motor 38 or the output spindle 20. In another example, the speed of the motor 38 can be controlled with combinations of open loop and closed loop speed control. One such configuration is shown in U.S. Pat. Reissue No. 33,379, reissued on Oct. 9, 1990, the disclosure of which is hereby incorporated by reference as if fully set forth herein. Once the kickback condition has been cleared, the tool 10 can be restarted by an output from a reset 44 to either or both of the kickback sensor 30 and the anti-kickback control device 32. In another example, reset can occur simply by first releasing the trigger 24 and subsequently depressing the trigger 24.

Those skilled in the art will understand that in the normal operation of the power tool 10, there will be an increase in motor current whenever a tool implement (i.e., a bit) engages a workpiece. This increase in current, however, will be within allowable and predictable limits. Even in the case of an overload condition, the increase in current is still much less in terms of the rate of change than that which occurs in a kickback condition just prior to lockup of the tool implement with the workpiece. In fact, in the overload condition, the power driven tool 10 or other implement continues to rotate, or cut the workpiece but at a slower speed, with the result that a thermal circuit breaker may be tripped. Neither of these conditions will occur in kickback. Kickback occurs in a such a short period of time that no significant heating takes place such that a thermal relay would trip. The threshold value should be set at a level which will permit detection of a kickback condition in a sufficiently short period of time to allow action to be taken to prevent lockup between the power driven tool 10 and the workpiece. This will vary depending on the motor used, the total inertia of the power tool and the normal operating speed of the tool, but this may be readily established by routine tests for any given power tool. Moreover, the threshold value need not be a preset value but may vary with operating conditions such as speed of the tool.

It is important to note here that while it is desirable to detect a kickback condition in a relatively short period of time, the principle criteria is to detect the kickback condition and take some action such as turning off the power and/or applying the brake 40 in a period of time which is shorter than the period of time it takes for actual lockup of the power driven tool 10 or other implement with the workpiece. With wood as a workpiece, lockup may take place in as short a period of time as 10 milliseconds or as long a period of time as 200 milliseconds or more. Therefore, it is generally sufficient to specify that detection of the kickback condition plus action time to prevent kickback be made in a period of time of less than 10 milliseconds.

In a typical implementation, the time it takes to detect a kickback condition can be varied by adjusting the level of a threshold voltage signal. By making the level relatively small, a kickback condition can be detected in a relatively short period of time, but, in addition, there will be a number of false detections which is not desirable. In practical implementations of the disclosure, this has not been a problem because the threshold level can be set sufficiently high as to avoid false detections and yet detect a kickback condition in a sufficiently short period of time to allow some action to be taken to prevent the kickback.

According to one example of the present teachings, the kickback control switch 34 may have two or more settings in which an operator may selectively adjust the sensitivity of the detection of a kickback event. The exemplary switch 34 has three settings, A, B and C however, more or less settings may be provided. The switch 34 may be a slidable switch, as illustrated, having two or more positive nesting positions along a track 48. Other switches, such as a multi-pole selector switch, a potentiometer, a dial or knob, may similarly be employed for allowing a user to select among two or a plurality of positions (thresholds). In this way, movement of the switch 34 can communicate various signals to a printed circuit board (PCB) 50 and/or the anti-kickback control device 32. The signals can correspond to various threshold values indicative of a kickback condition. In one example, the thresholds can correspond to various rates of current change. As a result, a user can set a desired sensitivity of anti-kickback control for a given task, such as a “high” setting corresponding to sensitive detection of a kickback event or a “low” setting corresponding to less sensitive detection of a kickback event. In another example, the switch 34 may alternatively or additionally include an “OFF” setting. In the “OFF” setting, anti-kickback control can be turned off entirely. A second position can correspond to an “ON” setting. In the “ON” setting, anti-kickback control can be turned on.

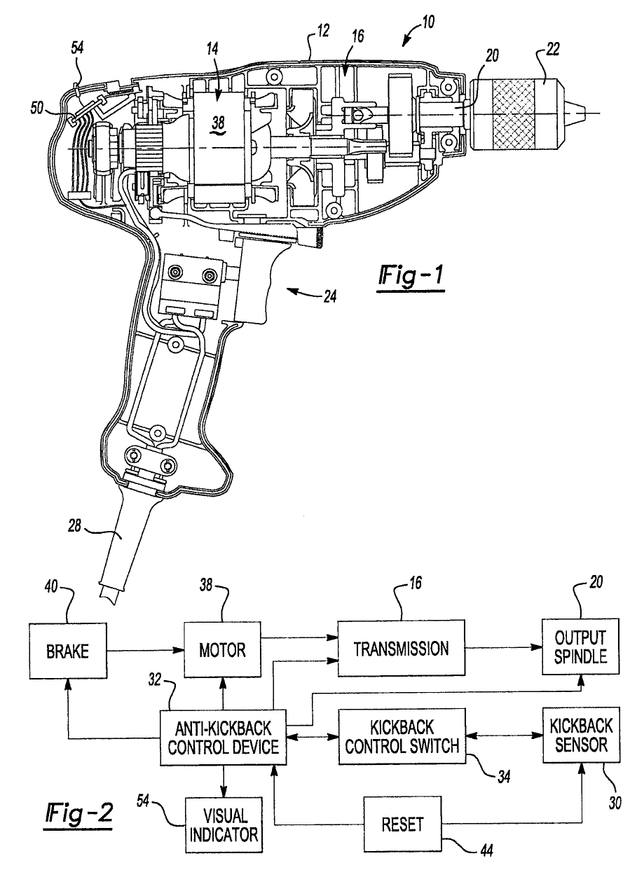

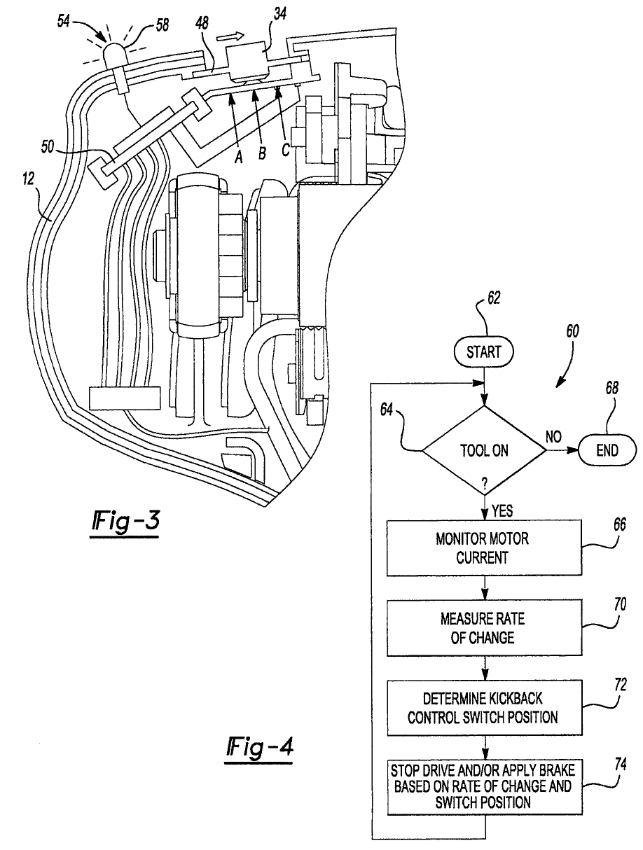

With reference to FIGS. 1 and 2, the tool 10 may also include a visual indicator 54. The visual indicator 54 may comprise an LED 58 that is in electrical communication with the PCB 50 and/or the anti-kickback control device 32. The anti-kickback control device 32 can control the illumination of the LED 58 based on the detection of a kickback event. In this way, the output of the anti-kickback control device 32 for illuminating the LED 58 can be a function of the rotational speed (RPM) of the electric motor 38. As can be appreciated, illumination of the LED 58 can communicate to a user that a kickback condition has occurred in the tool 10. In this way, illumination of the LED 58 is not the result of a tool malfunctioning, but rather an indication to the user that a kickback condition has occurred.

With reference now to FIG. 4, an exemplary method of operating the tool 10 is shown and generally identified at reference 60. Control begins in step 62. In step 64, control determines if the power tool 10 is on. If the power tool 10 is on, the motor current is monitored, such as by the kickback sensor 30 in step 66. If the power tool 10 is not on, control ends in step 68. In step 70, the rate of change of the motor current is measured, such as by the anti-kickback control device 32 based on an output from the kickback sensor 30. In step 72, control determines a position of the kickback control switch 34. In step 74, the motor 38 is stopped and/or the brake 40 is applied based on the rate of change determined by the anti-kickback control device 32 and the position of the kickback control switch 34. Control then loops to step 64.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A power tool comprising:
a housing;
a motor assembly in the housing, the motor assembly including an output member and a motor for translating the output member;
a kickback sensor that senses an operational rate of change of one of the motor and output member and produces an output in response thereto;
an anti-kickback control device that removes energy from the output member in response to the output of the kickback sensor; and
a switch having a first setting and a second setting, the first setting corresponding to a first operating condition of the anti-kickback control device and the second setting corresponding to a second operating condition of the anti-kickback control device.

2. The power tool of claim 1 wherein the kickback sensor samples successive periods of current through said motor.

3. The power tool of claim 1 wherein the first operating condition of the anti-kickback control device includes an “OFF” setting wherein the anti-kickback control device is turned off.

4. The power tool of claim 2 wherein the first operating condition includes a first threshold corresponding to a first rate of current change and the second operating condition includes a second threshold corresponding to a second rate of current change.

5. The power tool of claim 1, further comprising a visual indicator, wherein the anti-kickback control device communicates a signal to the visual indicator based on the output of the kickback sensor.

6. The power tool of claim 1 wherein the switch comprises a slidable switch configured on an upper portion of the housing.

7. The fastening tool of claim 1, further comprising a reset switch in electrical communication with the anti-kickback control device, the reset switch operable to restart the power tool subsequent to a kickback condition being cleared.

8. The power tool of claim 3 wherein the switch has a third setting corresponding to a third threshold and a third rate of current change.

9. A power tool comprising:
a housing;
a motor assembly in the housing, the motor assembly including an output member and a motor for translating the output member;
a kickback sensor that samples successive periods of current through said motor and produces an output in response thereto;
an anti-kickback control device that stops the motor in response to the output of the kickback sensor; and
a visual indicator, wherein the anti-kickback control device communicates a signal to the visual indicator based on the output of the kickback sensor.

10. The power tool of claim 9, further comprising a switch having a first setting and a second setting, the first setting corresponding to a first operating condition of the anti-kickback control device and the second setting corresponding to a second operating condition of the anti-kickback control device.

11. The power tool of claim 10 wherein the first operating condition of the anti-kickback control device includes an “OFF” setting wherein the anti-kickback control device is turned off.

12. The power tool of claim 10 wherein the first operating condition includes a first threshold corresponding to a first rate of current change and the second operating condition includes a second threshold corresponding to a second rate of current change.

13. The power tool of claim 10 wherein the switch comprises a slidable switch configured on an upper portion of the housing.

14. The fastening tool of claim 10, further comprising a reset switch in electrical communication with the anti-kickback control device, the reset switch operable to restart the power tool subsequent to a kickback condition being cleared.

15. The power tool of claim 10 wherein the switch has a third setting corresponding to a third threshold and a third rate of current change.

16. A method of eliminating kickback in a power tool of the type having an output spindle driven by an electric motor, the electric motor being supplied with current from an AC source, the method comprising:
sampling successive periods of current through the motor;
determining a rate of change of the current in response to the sampling;
comparing the rate of change to a threshold;
determining a selected position of a user actuated control switch having at least a first position and a second position; and
removing energy from the output spindle in response to the comparison and the position of the user actuated control switch.

17. The method of claim 16 wherein removing the energy includes inhibiting the supply of current to the motor if the rate of change exceeds the threshold.

18. The method of claim 16 wherein removing the energy includes applying a brake to the motor if the rate of change exceeds the threshold.

19. The method of claim 16, further comprising:
illuminating a light source based on the rate of change comparison.

20. The method of claim 16 wherein determining the position of the user actuated switch includes assigning a first threshold to the first position and a second threshold to the second position, the first and second thresholds corresponding to different rates of current change.
